(19) United States
(12) Patent Application Publication
(10) Pub. No.: US 2010/0194851 A1
(43) Pub. Date: Aug. 5, 2010

(54) PANORAMA IMAGE STITCHING

(75) Inventors: Sirish Kumar PASUPALETI, Bangalore (IN); Mithun ULIYAR, Bangalore (IN); P.S.S.B.K GUPTA, Bangalore (IN)

Correspondence Address: Workman Nydegger;1000 Eagle Gate Tower, 60 East South Temple, Salt Lake City, UT, 84111, US

(73) Assignee: ARICENT INC., George Town (KY)

(21) Appl. No.: 12/365,059

(22) Filed: Feb. 3, 2009

(51) Int. Cl. H04N 7/00; H04N 9/74

(52) U.S. Cl. 348/36; 348/584; 348/E07.001; 348/E09.055

(57) ABSTRACT

Systems and methods are disclosed for generation of a panoramic image of a scene. In an implementation, the method includes acquiring a plurality of images (e.g. first image and a second image) of the scene. Subsequent to image acquisition, the plurality of images is registered based on spatial relations of image data in an overlap region between the images. The spatial relations may correspond to distance and angle between a plurality of features in the first and the second images respectively. The registered images are merged based at least in part on a block based mean of the overlap region to generate the panoramic image. Block based merging is utilized to normalize spatially varying intensity differences of the first image and the second image.

### FIELD OF INVENTION

The disclosed methods and systems, in general relate to the field of registering images taken by panning around a scene and stitching the registered images to generate a panoramic image. In particular, the disclosed methods and systems relate to feature matching and intensity correction of images during the generation of panoramic images.

### BACKGROUND OF INVENTION

With advancements in digital image processing and digital image photography, generation of panoramic image of a scene (e.g. a landscape) has attracted lot of research and attention. Panoramic image of a scene is two-dimensional rendition of a three-dimensional scene of up to 360 degrees in circumference. The panoramic image is synthesized by taking video footage or multiple still photographs (images) of the scene, as the camera pans through a range of angles. Generation of panoramic images involves three major steps: image acquisition, image registration and image merging.

Image acquisition may be done by an image capturing device (e.g. a hand held camera). A user simply holds the camera and takes images of the scene by either rotating on the same spot or moving in a predefined direction roughly parallel to the image plane. In case of the user turning with the camera to obtain the images, the user acts as a tripod for the camera. In such an image acquisition method, it may be difficult to control the angles (both pan and rotation angles) between successive images and hence the acquired images may be difficult to register for generation of a panoramic image of the scene. It is often desirable to have large overlapping regions between successive images of the scene to reduce the effects of the above mentioned parameters (e.g. pan and rotation angles) during the acquisition of images by a hand-held camera. Larger overlapping regions imply that the camera rotations, or translations between successive images are smaller, thus reducing the amount of inconsistencies between images.

Image registration or alignment matches two or more images of the scene acquired at different instances of time, from different viewpoints and/or from different sensors. Typically, image registration involves spatially matching two images, i.e., the reference (first image) and target (second image) images, so that corresponding coordinate points in the two images correspond to the same physical region of the scene. Existing image registration techniques may be classified into three categories: Intensity-based methods, Feature-based methods, and Hybrid methods that combine both feature-based and intensity-based methods.

Image merging involves adjusting values of pixels in two registered images (reference and target images), such that when the images are joined, the transition from one image to the other is invisible. Typically, image merging involves: stitching line detection and blending and intensity correction.

Existing systems and methods for image registration face difficulties in correctly registering successive images of a scene, particularly when, during the time needed for adjusting the camera to a new position, objects within the scene move from their previous position and orientation. The difficulty in image registration is compounded when movable objects have to be included in a series of images of the scene. Also, varying degree of overlap between the successive images gives rise to difficulties in image registration.

In addition, existing systems and methods for panorama generation face the challenge of an intensity shift between successive (adjacent) images. Ideally, same region of an object should have the same intensity values in adjacent images. However, due to the variations in lighting intensity or angle between image capturing device and light source, the intensity values for the same region or object are different in adjacent images. Also, intensity shift between adjacent images may be introduced by contrast adjustment performed during the development of photographs, as well as during the scanning of the photographs.

Hence, there is a well-felt need for improved methods for image registration and intensity correction to generate panoramic images of very high objective and subjective quality while having a computationally simple processing method for easy implementation.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

The following embodiments and aspects of thereof are described and illustrated in conjunction with systems, tools, and methods which are meant to be exemplary and illustrative, and not limiting in scope. In various embodiments, one or more of the above-described problems have been reduced or eliminated, while other embodiments are directed to other improvements.

Systems and methods are disclosed for generation of a panoramic image of a scene. In an implementation, the method includes acquisition of a first image and a second image of the scene. The method further includes registering of the acquired first and second images based at least in part on spatial relations of image data in an overlap region between the first and the second images. The registered images undergo merging based at least in part on a block based mean of the overlap region to generate the panoramic image.

These and other advantages and features of the present invention will become more fully apparent from the following description and appended claims, or may be learned by the practice of the invention as set forth hereinafter.

### BRIEF DESCRIPTION OF FIGURES

The patent or application file contains at least one drawing executed in color. Copies of this patent or patent application publication with color drawing(s) will be provided by the Office upon request and payment of the necessary fee.

To further clarify the above and other advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail with the accompanying drawings in which:

FIG. 1 illustrates generation of a panoramic image of a scene from a series of image.

FIG. 2 illustrates an example embodiment of a system for generation of panoramic image in accordance to an embodiment of the present invention.

FIG. 3 illustrates a plot of mean intensity differences associated with an interim panoramic image in accordance with an implementation of the present invention.

FIG. 4 illustrates a plot of mean intensity differences in which random variations have been smoothed out by a second order polynomial fit.

FIG. 5 illustrates a method for matching feature points of left and right images of a scene for generation of panoramic image of the scene in an embodiment.

FIG. 6 illustrates the performance of the disclosed systems and methods for panoramic image generation.

### DETAILED DESCRIPTION OF THE FIGURES

State-of-the-art digital cameras can operate in a “panoramic image mode”, in which the digital camera is configured to capture few pictures or pan a video of a scene and stitch those pictures or video frames using various image processing techniques to produce a panoramic image. Existing techniques for generating panoramic images are subject to certain limitations because of their computational complexity, temporal artifacts, requirement of human intervention and moving objects etc.

Systems and methods are disclosed for generation of a panoramic image of a scene. In an implementation, the method includes acquiring a plurality of images (e.g. first image and a second image) of the scene. Subsequent to image acquisition, the plurality of images is registered based on spatial relations of image data in an overlap region between the images. Since the images are taken at multiple moments while the camera is panning around the scene, they need to be registered to each other in order to obtain the panoramic image. The overlap region may be adjusted during the acquisition of the images. The spatial relations correspond to distance and angle between a plurality of features in the first and the second images respectively. In an example embodiment, the image registration involves finding and correcting the rotation angle between the first and the second images. The registered images are merged based at least in part on a block based mean of the overlap region to generate the panoramic image. Block based merging is utilized to normalize spatially varying intensity differences of the first image and the second image.

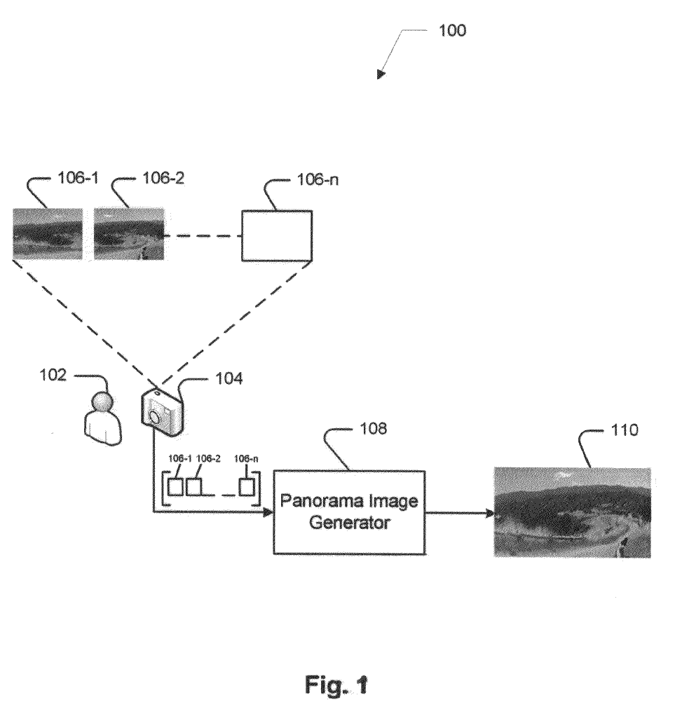

FIG. 1 shows generation of a panoramic image of a scene from a plurality of images. Accordingly, a user 102 utilizes an image acquisition device 104 to capture a plurality of images or video frames 106-1, 106-2, . . . , 106-n and so on of a scene for which the user 102 intends to generate a panoramic image. The image acquisition device 104 may include one of: digital camera, mobile phones, personal digital assistant (PDA), or other similar devices configured to capture images of a given scene.

FIG. 1 also shows a panorama image generator 108 that receives the plurality of images 106-1, 106-2, . . . , 106-n and generates a panoramic image 110 of the scene. It is to be noted that although, for purposes of general description, the panorama image generator 108 has been shown as a separate block outside the image capturing device 104, but the panorama image generator 108 can be implemented in the image acquisition device 104. Further, for purposes of description, two successive images (e.g. 106-1 and 106-2) have been considered. It will be appreciated that the processing of images can extend to the plurality of images 106-1, 106-2, . . . , 106-n.

In an example implementation, the image acquisition device 104 operates in a “panoramic image generation” mode. In such a mode, the panoramic image generator 108 is configured to acquire a plurality of images for a given scene. For generation of a panoramic image of a scene, the plurality of images is captured by moving the camera across the scene of interest or about an axis. In general, there are three types of movements possible for the image acquisition device 104: the camera panning (rotation around y-axis), tilt (rotation around x-axis), and rotation (rotation around z-axis). Out of the three movements, the rotation (around z-axis) of the image acquisition device 104 tends to happen while capturing the plurality of images for generation of panoramic images. The rotation transforms the image content of a second image (e.g. 106-2) w.r.t overlap content in a first image (e.g. 106-1) significantly as compared to the other movements of the image acquisition device 104. The panorama image generator 108 finds and corrects the rotation angle between the first image 106-1 and the second image 106-2.

The image acquisition device 104 captures the plurality of images 106-1, 106-2, . . . , 106-n at different moments while the image acquisition device 104 pans across the scene. For example, the plurality of images of the scene can be captured by the image acquisition device 104 at different instances, from different viewpoints and/or from different sensors. The plurality of images thus captured have to be spatially matched, so that corresponding coordinate points in any two successive images (first image 106-1 and second image 106-2) correspond to the same physical region of the scene being imaged.

To this end, the panorama image generator 108 spatially matches or registers the plurality of images 106-1, 106-2, . . . , 106-n to each other. The panorama image generator 108 is configured to perform the image registration based on spatial relations of image data in an overlap region between two successive images (e.g. first image 106-1 and the second image 106-2). The spatial relations correspond to distance and angle between plurality of features in the two successive images respectively. The panoramic image generator 108 employs one of the processing techniques like, for example, intensity-based techniques, feature-based technique, and hybrid techniques that combine both feature-based and intensity-based techniques. Feature-based techniques attempt to identify edges, corner points, contours, trajectories, or other features that are common in the reference and target images (e.g. 106-1 and 106-2). The putative correspondences between the features are obtained by comparing the image neighborhoods around the features using a similarity metric such as the normalized cross-correlation.

Image registration further includes detection of a plurality of features in two successive images (e.g. the first image 106-1 and second image 106-2). Subsequent to detection of features, the panoramic image generator 108 performs feature matching based on the spatial relations of image data in an overlap region between two successive images. The extent of overlap region can be controlled during image acquisition by the image acquisition device 104 to facilitate a better feature matching results. For feature matching, the disclosed methods and systems assumes that there exist two sets of features in the reference and target images represented by Control Points (CPs) that have been detected. The aim is to find the pair-wise correspondence between the two sets of features using their spatial relations or various descriptors of features. The spatial relations may be information associated with the spatial distribution and distance and angle between the CPs.

Subsequent to detection and computation of an initial set of feature correspondences, the panorama image generator 108 finds a set that will produce a high accuracy alignment. In an embodiment, the panorama image generator 108 computes a least squares estimate or use a robust version of least squares estimates.

After the feature correspondence has been established, the panorama image generator constructs a mapping function to transform the first image 106-1 to overlay it over the second image 106-2. In a successive progression, the panorama image generator computes image values in non-integer coordinates by interpolation techniques. The mapping functions constructed by the panoramic image generator are used to transform the second image 106-2 (target image) and thus to register the first image 106-1 and the second image 106-2. The transformations of the second image 106-2 can be realized in a forward or backward manner. Each pixel from the second image 106-2 or the target image can be directly transformed using the estimated mapping functions. The registered image data from the target image 106-2 is determined using the coordinates of the target pixel (the same coordinate system as of the first image 106-1 or the reference image) and the inverse of the estimated mapping function.

The panoramic image generator 108 merges the plurality of images by adjusting the values of pixels in registered images (e.g. first image 106-1 and second image 106-2), such that when the registered images are joined, the transition from one image to the next is invisible. Also, the merged images preserve the quality of the input images (106-1 and 106-1) as much as possible. Image merging includes stitching line detection and blending and intensity correction of the registered images.

The registered images are stitched to avoid misalignments and objects moving in the scene by finding a strip (stitching line) in the overlapping region that gives the minimum error. After the stitching line is determined, blending is applied across the stitch so that the stitching would be seamless. Subsequent to stitching and blending, the panorama image generator 108 performs intensity correction over the stitched images. In an ideal case, the overlapping region of adjacent images (e.g. 106-1 and 106-2) should be identical, so that the intensity values of left overlapping portion of the image are equal to intensity values of the corresponding position in the right image for any point (i, j). However, due to various reasons, including the lighting condition, the geometry of the camera set-up, the overlapping regions of adjacent images are almost never the same. Therefore, removing part of the overlapping regions in adjacent images and concatenating the trimmed images often produce images with distinctive seams.

One of the objectives of the intensity correction is to merge the images so that the seam between images is visually undetectable. The second objective is to preserve the quality of the original images as much as possible. So that merged image is not seriously degraded by the intensity adjustment required to remove the seam.

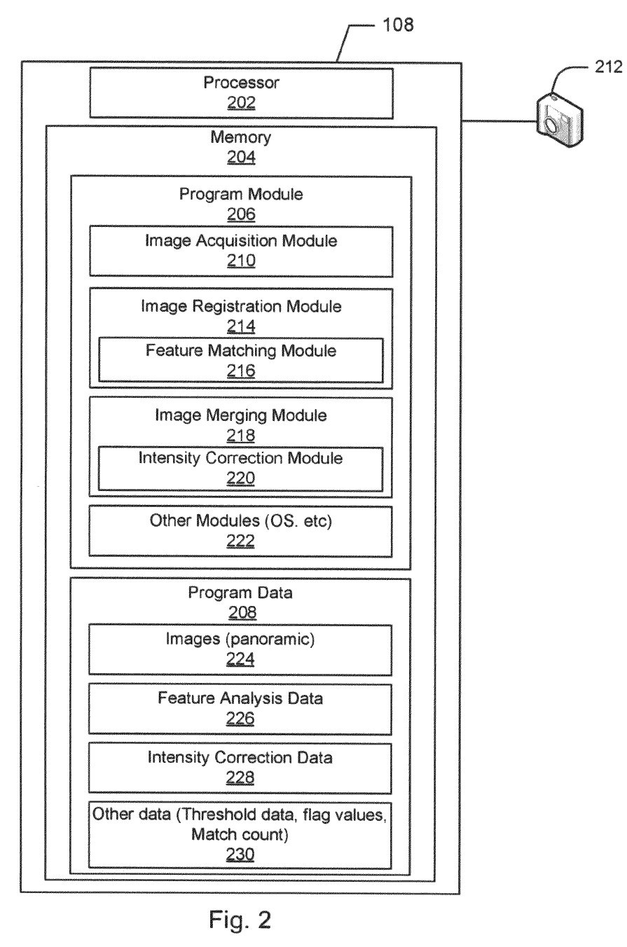

FIG. 2 shows a system for panoramic image generation according to an implementation. It is noted here that although the system 108 is shown as a separate block, the system 108 can be implemented inside an image acquisition device (e.g. 104). Typical examples of such implementations include digital cameras, mobile phones with cameras, etc. Accordingly, the system (panoramic image generator) 108 includes a processor 202 coupled to a memory 204. The memory 204 includes program modules 206 and program data 208.

The program modules 206 include one or more modules configure to perform one or more functions when executed by the processor 202. The functions could be, for example, one of the plurality of steps involved in panoramic image generation. For instance, the program modules 206 include an image acquisition module 210, functionally coupled to an image acquisition device 212 (or 104) configured to acquire a plurality of images or video frames corresponding to a scene. The image acquisition module 210 coordinates the capturing of the images by the image acquisition device 212. The program module 206 further includes image registration module 214 that further includes a feature matching module 216. The program module also includes image merging module 218 that further includes intensity correction module 220. The processor 202 executes one or more of the program modules 206 in conjunction with other modules 222 that includes operating system and other application software required for panoramic image generation.

The program data 208 stores static data (constant value data) and dynamic data (variables) utilized for various computations in the process of panoramic image generation. For instance, the program data 208 includes image 224, feature analysis data 226, intensity correction data 228 and other data 230.

### Image Acquisition

In operation, the image acquisition device 212 captures the plurality of images 106-1, 106-2, . . . , 106-n at different moments by panning across the scene of interest and stores the captured images in panoramic image 224. The plurality of images thus captured have to be spatially matched, so that corresponding coordinate points in the any two successive images (first image 106-1 and second image 106-2) correspond to the same physical region of the scene being captured. It may be noted that for general purpose of illustration and description of the feature matching algorithm, the image 106-1 has been interchangeably referred to as “left image” or “first image”. Similarly, the image 106-2 has been interchangeably referred to as “right image” or “second image”.

### Image Registration

The program module 206 includes an image registration module 214 configured to spatially match or register the plurality of images captured by the image acquisition device 212. Image registration entails the processes of: detection of one or more features (or feature points) in the plurality of images (e.g. first image 106-1 and 106-2), matching of features (or feature points) based on spatial relation of image data in the overlap region between the first image 106-1 and the second image 106-2, estimating transformation model for transforming the second image 106-2 to overlay over the first image 106-1, and performing image re-sampling and transformation.

### Feature Detection:

It is desirable that the features are easily detectable, and the detected features have common elements, even in situations when the images do not cover exactly the same scene. In order to get reasonably good image registration result, a large number of common features are selected and those are spread over the one or more images (106-1, 106-2, etc.) captured by the image-capturing device 212. The detected/selected features are stored in the image analysis data 226.

The most common and widely used feature for feature detection is the “corner”. Corners form specific class of features, because ‘to-be-a-corner’ property is hard to define mathematically (intuitively, corners are understood as points of high curvature on the region boundaries). Corners are image regions that have significant gradient in more than one direction. These form prominent image features and can be detected efficiently in both the images under consideration. In an implementation, the detection of the one or more features is performed using Harris Corner detection method. The Harris corner detector is rotation invariant, and invariant to affine and intensity changes, i.e. it has good repeatability rate. It has good localization and fair robustness to noise. However, it may be appreciated that other detection techniques known in the art may be employed for feature detection without deviating from the spirit of the disclosed methods and systems for panoramic image generation.

### Feature Matching:

The image registration module 214 includes a feature matching module 216 configured to match one or more detected features based at least in part on the spatial relations of image data in the overlap region between any two consecutive images (e.g. 106-1 and 106-2). The feature-matching module 216 exploits the distance and angle between detected features/feature points of the captured images. The motivation for feature matching based on spatial relationship is the fact that spatial relationships gives a reliable measure for the accurate alignment of the images and is less complex compared to the state of the art algorithms.

Subsequent to detection of features, the correspondences between the detected features in both the first image and second image are determined. Also, the feature matching strategy depends on the transformation model used. In an embodiment, rotational transformation model is utilized for transforming the second image 106-2 to overlay on the first image 106-1 to support the rotation of features in the x-y plane while capturing the one or more images. Also, the feature matching module implements an algorithm based on Gray scale space domain.

The feature matching module 216 finds the required number of feature points in both left and right images (first image 106-1 and second image 106-2) and assigns a numbering to feature points based on their X axis co-ordinate prior to storing them in the feature analysis data 226. Subsequently, the feature matching module 216 executes the feature matching algorithm. The feature matching process is an iterative process and stops only after exhausting all possible permutations and combinations for selecting the feature points in the left image and the right image.

The feature matching module 216 selects a pair of feature points in the left image 106-1 and the right image 106-2 of the scene. These feature pairs are also referred to as “parent pairs”. These pairs are selected in the order based on the numbering given to the feature points. For example, if there are 10 features in the left image, features numbered 1 and 2 are selected first. The feature matching module 216 then determines a first left distance and a first right distance between the selected pair of features in the left image and the right image respectively. The feature matching module 216 also determines a first left angle and a first right angle between the selected pair of features in the left image and the right image respectively. The feature matching module 216 stores the first left distance, the first right distance, the first left angle, and the first right angle in the feature analysis data 226.

The feature matching module 216 then computes a first adaptive distance threshold corresponding to the first left distance. The first distance threshold is set adaptively based on the distance between feature pair co-ordinates of the left image 106-1. A rigid distance threshold is undesirable because as the distance between the feature pair increases, the amount of spatial inconsistency (difference in spatial location and angle) of the same feature pair in the other image (right image 106-2) may increase. Hence, a larger adaptive distance threshold may be usually set.

Spatial inconsistency is due to the variations in the camera parameters (tilt, rotation, scaling, panning, etc.) while capturing the panoramic images (e.g. 106-1, 106-2, etc.). For example, the adaptive thresholds is empirically set to 2 (Small Threshold—ST) if the left distance (first left distance) is less than 35 (Distance Small Threshold—DST). Alternately, the adaptive distance threshold is empirically set to 4 (Medium Threshold—MT) if the left distance is less than 100 (Distance Medium Threshold—DMT). Alternately, the adaptive distance threshold is empirically set to 6 (Large Threshold—LT) if the left distance is greater than 100 (Distance Medium Threshold—DMT). The adaptive setting of distance thresholds improves the accuracy of correct feature matches. The adaptive distance threshold is stored in the other data 230.

The feature matching module 216 determines a first difference between the first left distance and the first right distance and compares the determined first difference with the first adaptive distance threshold. The feature matching module 216 stores the first difference in the feature analysis data 226. The idea is to make sure that the difference between two features in both left image and right image respectively are within a range for the features to be declared as matched features.

The feature matching module 216 further determines, based on the comparing of the determined first difference with the first adaptive distance threshold, a difference between the first left angle and the first right angle and stores the difference in the feature analysis data 226. The difference between the first left angle and the first right angle gets adjusted whenever it goes above 90 degrees by finding the rotation direction for the feature pairs in both the images (left image and right image) with respect to each other and assigning 1 for clock wise rotation and −1 for anti clock wise rotation.

Subsequently, the feature matching module 216 determines a first rotation direction based on the first left angle, first right angle and the determined difference between the first left angle and the first right angle. The rotation direction is indicated by a flag value and is stored in the feature analysis data 226. The determined difference between the first left angle and the first right angle is compared with an angle threshold. The feature matching module 216 sets the angle threshold for the comparison. The feature matching module 216 sets the angle threshold to, for example, +or −15 degrees, which would support 15 degree clock wise rotation and 15 degree anti clock wise rotation. The angle threshold is stored in other data 230.

Based on the comparison, the feature matching module 216 selects a second feature in the left image and a third feature in the right image. The feature matching module 216 further determines a second left distance between the second feature and one of the selected pair of features in the left image. Similarly, a second right distance between the third feature and one of the selected pair of feature in the right image is determined. The feature matching module 216 stores both the second left distance and the second right distance in the feature analysis data 226.

The feature matching module 216 determines a second left angle between the second feature and the one of selected pair of features in the left image and a second right angle between the third feature and the one of selected pair of features in the right image. A second adaptive distance threshold corresponding to the second left distance is determined in a way similar to the first adaptive distance threshold. The feature matching module 216 stores the second left angle and the second right angle in the feature analysis data 226. The second adaptive distance threshold is stored in other data 230.

The feature matching module 216 determines a second difference between the second left distance and the second right distance and compares the determined second difference with the second adaptive distance threshold. Based upon the comparison, the feature matching module 216 determines a difference between the second left angle and the second right angle. Subsequently, a second rotation direction is determined based on the second left angle, second right angle and the determined difference between the second left angle and the second right angle. The feature matching module 216 stores the second rotation direction, the determined differences between the distances and the determined angles in the feature analysis data 226.

Having computed the first and second rotation directions, a rotation flag (stored in other data 230) is set (to 1) based on a comparison of the first rotation direction and the second rotation direction. The determining of the first and second rotation direction involves adjusting the differences between the first and second left angles and first and second right angles respectively. In an implementation, the rotation directions are assigned a value of −1 or +1 to represent anti-clockwise direction and clockwise direction respectively. Also, the first and second rotation directions may be discarded if either of the corresponding first and second angle differences are less than or equal to 3.

The feature matching module 216 iterates the algorithm by matching the geometrical properties of the parent pair from the left image (106-1) with all the possible pairs in the right image (106-2). Subsequent to the matching of parent pair, the feature matching module 216 takes the immediate higher numbered feature point from the left image (e.g. feature point number 3), pairs it with the first feature point in the initial matched pair (e.g. feature point number 1) and forms a new pair referred to as “child pair1” (containing features numbered 1 and 3). The feature matching module 216 tries to match the new selected pair (child pair1) from the left image (106-1) with all the possible pairs with the higher numbered feature points corresponding to the initial match pair in the right image.

If a match exists for the parent pair among the pairs in the right image, the match is referred to as “initial match pair” and is stored in a matched set in other data 230. It may be noted that there may be several matched sets containing the matched feature points.

The feature matching module 216 continues to perform feature matching till the last feature point (highest numbered feature point) in the left image is paired with the first feature point in the first parent pair.

Subsequent to the matching of all the parent pairs that are possible with the feature point numbered 1, the feature matching module 216 takes the next parent pair (e.g. feature point numbered 2 and feature point numbered 3) from the left image and performs the feature matching till the last parent pair in the left image. It is noted that while comparing the distance of a feature pair in both the images, the adaptive threshold is computed based on the left feature pair distance for each comparison.

As described supra, the feature matching module 216 stores all the matched features/feature points in the matched set in other data 230 and increases the match_cords_count (stored in other data 230). In an alternative embodiment, early stop mechanism is used in the feature matching to stop the processing. Such a mechanism uses two criteria: best match set and no of predominant match sets. A matched set is referred to as the “best match set” if the number of matched pair of features in the generated set exceeds a “best match count”. In such a case, further processing is stopped. A matched set is referred to as the “predominant match set” if the number of matched pair of features in the generated set exceeds a “predominant match count”. If the no of predominant match sets generated in the feature matching exceeds a “predominant set threshold”, further processing is stopped. In an implementation, the best match count is set to 16. In another implementation, the predominant match count is set to 10 and predominant set threshold is set to 15. It has been observed that about 50% of the inputs result in best matches.

Upon determination of a matched set, a feature pair (in the match set) which meets the entire matching criterion with initial matched pair, has to undergo one more criterion, for example, the features distance should be consistent with distance of the matched features (with more than 75% of features) that are there in the matched set. If this condition is met, the feature pair is to be selected in to the matched set and the FlagSuccess flag is set to one.

In case of no “best match set”, the feature matching module 216 considers the matched sets obtained as a result of the feature matching process described above. Some of these sets may indicate a wrong match. In such a case, the feature matching module 216 finds the correct match set by identifying the predominant matched set(s) by arranging the sets of features in descending order of their size (i.e. no of matches in the set). If the no of matches in a given set is high, the likelihood for a correct match is also high. This is due to the fact that the feature matching module 216 does not allow large number of wrong matches in a set. The feature matching module 216 selects the first few sets and compares the distance of the initial feature match in each set. If 70% of the selected feature matches gives the same distance, then the feature matching module 216 select the first set as the correct match.

For example, if a good number of matched sets are considered with a substantial number of matches, then more than 75% of these matched sets corresponds to correct match sets. In an example embodiment, the feature matching algorithm may consider the average of the distances of five initial matched pairs in each set.

### Transform Model Estimation:

Subsequent to feature matching, the image registration module 214 estimates a transformation model for transforming the second image 106-2 to overlay over the first image 106-1. This is accomplished by constructing a mapping function that transforms the target image to overlay it over the reference one. The type of the mapping functions is chosen according to a priori known information about the image acquisition process and expected image degradations in the acquired images. The image registration module 214 stores the mapping function in other data 230.

To find the relationship between two images, image registration module 214 relies on estimation of parameters of the transformation model. The number of parameters depends on the chosen transformation model. Similarity transform is the simplest model and it consists of rotation, translation and scaling. In an exemplary implementation, the image registration model 214 employs a rotational transformation model that supports rotation (x-y plane rotation).

By way of example, the transformation model may be composed of rotation and translation as given below, which maps the pixel (x2, y2) of image I₂ (e.g. 106-2) to the pixel (x1, y1) of another image I₁(e.g. 106-1).

$$[ \begin{matrix}x 1 \\ y 1\end{matrix} ] = R [ \begin{matrix}x 2 \\ y 2\end{matrix} ] + T ,$$

where R is the Rotation matrix and T is the Translation matrix, as given below,

$$R = [ \begin{matrix}Cos θ & - Sin θ \\ Sin θ & Cos θ\end{matrix} ]$$

$$and , T = [ \begin{matrix}{t}_{x} \\ {t}_{y}\end{matrix} ]$$

### Image Re-Sampling and Transformation:

Subsequent to estimation of transformation model, the image registration module 214 performs the re-sampling and transformation by computing image values in non-integer coordinates using appropriate interpolation techniques. The image registration module 214 stores the computed image values in other data 230. As discussed earlier, the image registration module 214 employs the mapping functions constructed in the previous section to transform the target image and thus to register the captured images (106-1, 106-2, . . . , 106-n). The transformations can be realized in a forward or backward manner. Each pixel from the target image is directly transformed using the estimated mapping functions. Such an approach, referred to as a forward transformation method, is complicated to implement, as it can produce holes and/or overlaps in the output image (due to discretization and rounding). Hence, the backward approach is usually chosen. The registered image data from the target image are determined using the coordinates of the target pixel (the same coordinate system as of the reference image) and the inverse of the estimated mapping function. The image interpolation takes place in the target image on the regular grid. In this way, neither holes nor overlaps can occur in the output image.

Even though the bilinear interpolation known in the art is outperformed by higher-order methods in terms of accuracy and visual appearance of the transformed image, it offers the best trade-off between accuracy and computational complexity and thus is used here.

In an implementation, the image registration module 214 resizes the input images (106-1, 106-2, etc.) to small dimensions (e.g. less than 250×200 pixels), process the images to get required matching parameters and scale them according to the resized ratio to create the final panoramic image. In such an implementation, the complexity involved in processing images is reduced substantially.

### Image Merging

### Stitching Line Detection and Blending:

The image merging module 218 merges the registered images to create a single panoramic image of the scene. Image merging involves stitching line detection and blending. Stitching is an important step to generate good panorama photos. In order to avoid misalignments and objects moving in the scene, the image merging module 218 attempts to stitch across the best agreement. The best agreement corresponds to a strip in the overlapping region between the left and right images that gives the minimum error.

After the stitching line is determined, the image merging module 218 applies blending across the stitch so that the stitching becomes seamless. It is noted that methods known in the art for blending the images are applicable for the purposes of ongoing description. For example, blending techniques like, alpha blending may be employed, which takes weighted average of the two images (e.g. 106-1 and 106-2). The weighting function is usually a ramp. At the stitching line, the weight is half, while away from the stitching line one image is given more weights than the other. A typical case where alpha blending works well is when image pixels are well aligned to each other. The blending is applied after the image intensities are normalized and the only difference between two images is the overall intensity shift.

Another example of blending approach is Gaussian pyramid. This method essentially merges the images at different frequency bands and filters them accordingly. The lower the frequency band, the more it blurs the boundary. Gaussian pyramid blurs the boundary while preserving the pixels away from the boundary. It may not work well, however, if the two images are at significantly different intensity levels. In such a case, the transition is not as smooth as alpha blending. The image merging module 214 generates an interim panoramic image as a result of the stitching and blending of the first image and second image and stores the interim panoramic image in images 224.

### Intensity Correction:

For generation of high quality panoramic images, the overlapping region of adjacent images should be identical, so that the intensity values of left overlapping portion of the image are equal to intensity values of the corresponding position in the right image for any point (i, j). However, due to various reasons, including the lighting condition, the geometry of the camera set-up, the overlapping regions of adjacent images are almost never the same. Therefore, removing part of the overlapping regions in adjacent images and concatenating the trimmed images often produce images with distinctive seams. A “seam” is referred to as an artificial edge produced by the intensity differences of pixels immediately next to where the images are joined.

One of the objectives of the intensity correction is to merge the images so that the seam between images is visually undetectable. The second objective is to preserve the quality of the original images as much as possible so that merged image is not seriously degraded by the intensity adjustment required to remove the seam.

One of the approaches known in the art to remove the seam is to perform intensity adjustment locally, within a defined neighborhood of the seam, so that only the intensity values in the neighborhood are affected by the adjustment. Another approach is to perform a global intensity adjustment on the images to be merged, so that apart from the intensity values within the overlapping regions, intensity values outside the overlapping regions may also need to be adjusted.

Image merging techniques known in the art face problems of spatially varying intensity shift between adjacent images. In an ideal case, it is desirable that the same region or object have the same intensity values in adjacent images. However, due to the variation in the lighting intensity, or the angle between the camera and the light source, the intensity values for the same region or object are different in adjacent images. Other causes for intensity shift between adjacent images include the contrast adjustment performed during the development of photographs, as well as, during the scanning of the photographs, both of which can be avoided if a digital camera is used to acquire the images in the first place.

The disclosed system and method of panoramic image generation employs intensity correction algorithm based on block based mean of the overlap regions in two images (e.g. 106-1, 106-2). Mean differences in each of the color planes are smoothed out using a second order least squares polynomial fit. Such an approach will effectively normalize the spatially varying intensity differences of both the images.

The intensity correction method employed by disclosed systems and methods perform the global intensity adjustment on the images to be merged (registered images). The idea is to increase the exposure of an image having less total mean in the overlap region. The intensity shift is not a simple scalar shift, i.e. different regions in the image will be having different intensities and so the intensity differences of different regions in the overlap regions of both the images will be different. This is due to various reasons, including the lighting condition and the geometry of the camera set-up. Hence, the total mean intensity difference of the total overlap regions of both the images (first and second) is not a good measure of spatially varying intensity differences. Hence, a block based approach effectively normalizes the spatially varying intensity differences of both the images.

The image merging module 218 includes an intensity correction module 220 that computes block wise mean intensity differences in the overlap region between the one or more registered images for each of the color planes associated with the scene. The intensity correction module 220 stores the mean intensity differences in the intensity correction data 228. The color planes may correspond to the RGB, CMYK, gray space and the like. The block in the overlap region is characterized by a predefined dimension, for example, a dimension of up to 20 rows and up to 50 columns on each side of a stitch point between the one or more registered images. The intensity differences can be monotonously increasing or decreasing functions or combination of both (i.e. functions representing upper or lower parabola). Hence, the intensity correction module 220 defines a functional model that takes into consideration all the three possible functional behaviors. The functional model so defined is stored in the intensity correction data 228.

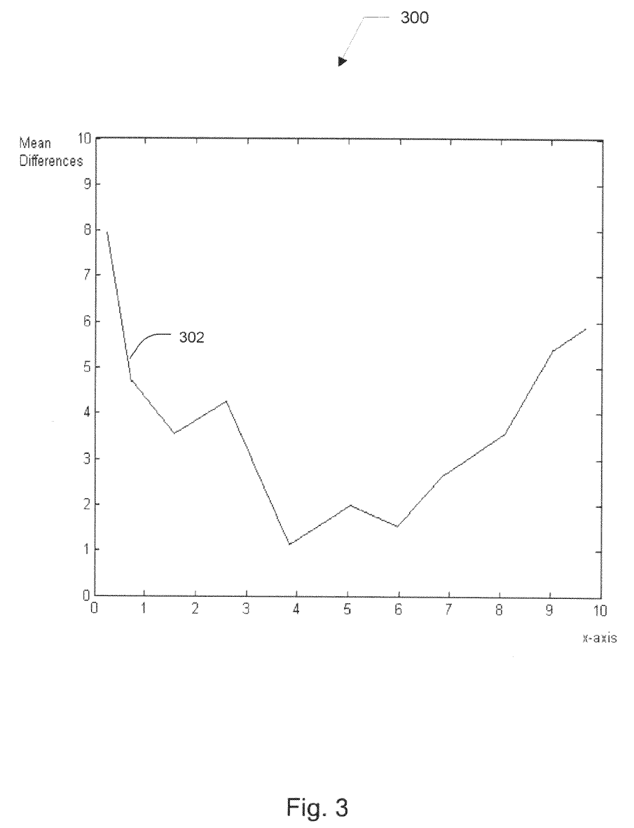

The intensity correction module 220 represents the random variations in the computed mean intensity differences by a curve. FIG. 3 shows an example plot of mean intensity differences where the intensity differences are represented by a curve 302. The x-axis corresponds to the block number.

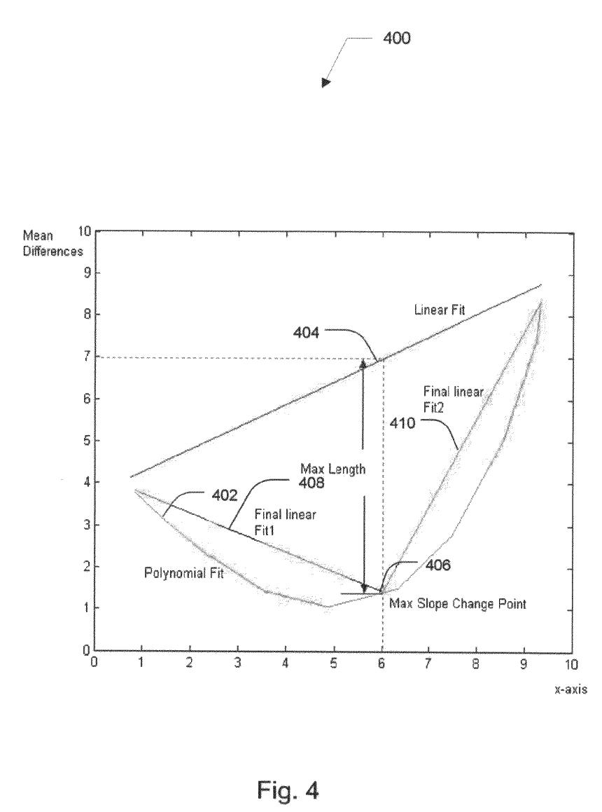

The curve is smoothened by a second order polynomial fit curve. FIG. 4 shows a curve 402 which is a smoothened version of the curve representing the mean intensity differences of all the blocks. The intensity correction module 220 finds a linear fit 404 between the first and last values of the smoothened curve 402. The linear fit 404 corresponds to a straight line between first and last values of the smoothened curve 402 using a first order least squares polynomial fit.

The intensity correction module 220 determines a maximum slope change point 406 on the first order least squares polynomial fit curve 402. The maximum slope change point 406 corresponds to x-coordinate of the first order least square polynomial fit curve 402 at which distance between the linear fit 404 and the first order least squares polynomial fit curve 402 is maximum. In other words, the maximum slope change point 406 indicates that, the slopes of the intensity variations before and after that point are significantly different.

The intensity correction module 220 further determines maximum slope change points (e.g. 406) for intensity differences corresponding to each of the plurality of color planes (e.g. R, G, B color planes). The calculation of slope change point needs to be done for each color plane intensity differences. The final slope change point is found by average of all the three color plane slope change points (maximum slope change points), because all the color planes have approximately same kind of intensity differences.

The intensity correction module 220 further determines a final linear fit that corresponds to a first straight line 408 between the first value and the maximum slope change point 406 and a second straight line 410 between the maximum slope change point 406 and the last value on the first order least squares polynomial fit curve 402.

The intensity correction module 220 normalizes an interim panoramic image stored in images 224 (obtained subsequent to stitching and blending of the one or more registered images) by using the mean intensity difference data associated with the final linear fit (408 & 410).

In case, the maximum slope change point 406 occurs at less than 3 (x co-ordinate) or greater than endpoint (x co-ordinate) −3, then it may imply some initial or final abrupt changes in the intensity differences. In such a case, the maximum slope change point 406 is not considered and total intensity differences are modeled as a linear fit 404.

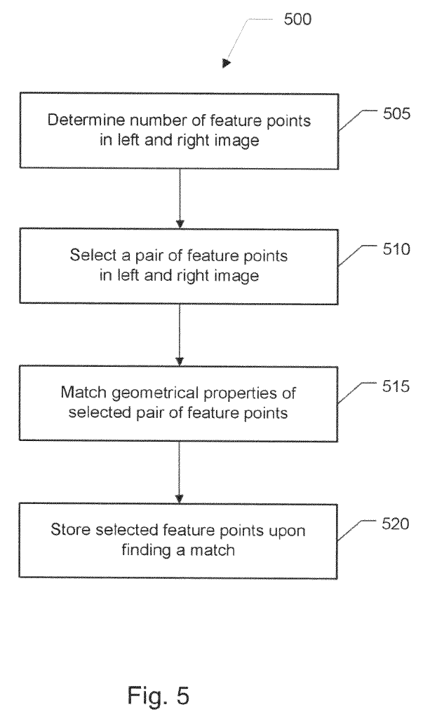

FIG. 5 illustrates a method for matching feature points of a left image and a right image of a scene captured for generating panoramic image of the scene. The left and right images can be, for example, images 106-1 and 106-2 respectively, as shown in FIG. 1.

At block 505, a number of feature points are determined in the left image 106-1 and the right image 106-2. In an implementation, the image registration module 214 determines the number of features in the left image 106-1 and the right image 106-2 and stores them in the feature analysis data 226. The process of determining the number of feature points entails the detection of features by means of feature detection techniques. In one of the embodiments, the image registration module 214 detects features points in the left and the right images by Harris Corner Detection technique.

At block 510, a pair of features points are selected each from the left image and the right image. The feature matching module 216 numbers each of the features points in a given image (e.g. left image 106-1) and selects the first two features points (numbered 1 and 2) to constitute a parent pair. The feature matching module 216 also selects a pair feature points in the right image 106-2.

At block 515, geometrical properties of the selected pair of feature points in the left image and the selected pair of feature points in the right image are matched. The geometric properties include distance and angle between the selected pair of feature points in respective images. In operation, the feature matching module 216 performs a feature matching based on the geometric/spatial relations between the selected feature points in the left and the right images. The feature matching includes determination of a distance and an angle between the selected pair of feature points in the left image. Similarly, the distance and angle between the selected pair of feature points in the right image are also determined. The feature matching module 216 then compares the determined distances and the angles corresponding to the left image and the right image to determine whether a match has been found.

The feature matching module 216 then selects a new feature point in the left image and determines the distance and angle between the new feature point and one of the previously selected pair of feature points in the left image. This pair is referred to a child pair1. Similarly, the feature matching module 216 selects a new feature point in the right image and determines the distance and angle between the new feature point and one of the previously selected pair of feature points in the right image.

Subsequently, the feature matching module 216 compares the determined distances and the angles corresponding to the new corner feature points in the left image and the right image respectively to determine whether a new match has been found. The feature matching module 216 repeats the process of feature matching for all combinations of parent pairs (feature points in the left image) as discussed with reference to FIG. 2. The comparing of distances in cases of both the parent pair and the child pair1 includes determining an adaptive distance threshold based on the distance between the feature points in the left image. The comparing of angles in case of both the parent pair and child pair1 includes setting an angle threshold.

At block 520, the selected pairs of feature points are stored in a matched set upon finding a match. The feature matching module 216 stores the selected pairs of feature points in a matched set (in other data 230) when the pairs of feature points satisfy the criterion for feature matching. The criterion for feature matching has been explained in detail with reference to FIG. 2.

### Performance of the Disclosed Methods and Systems:

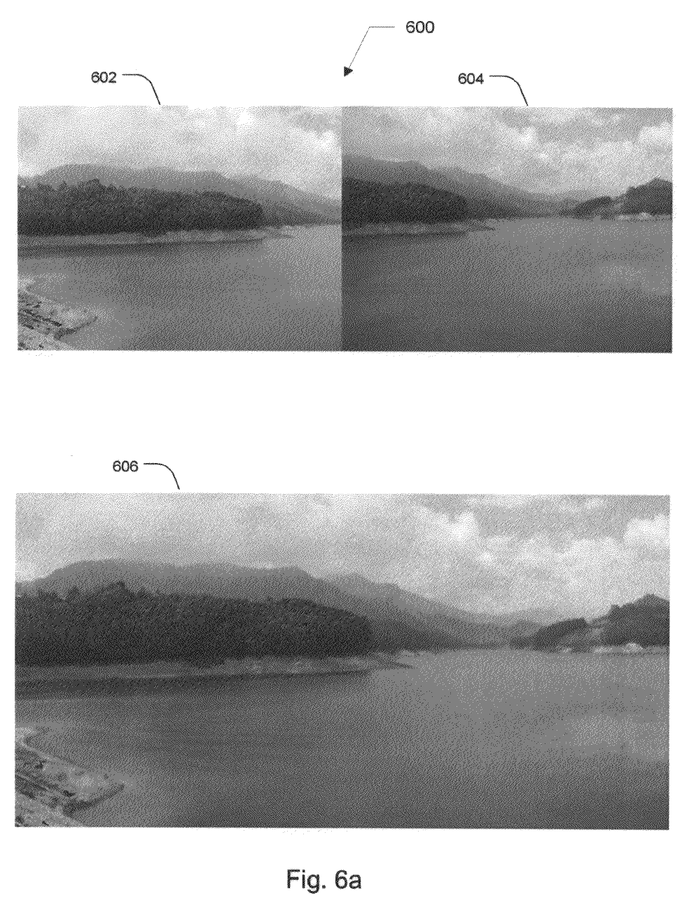

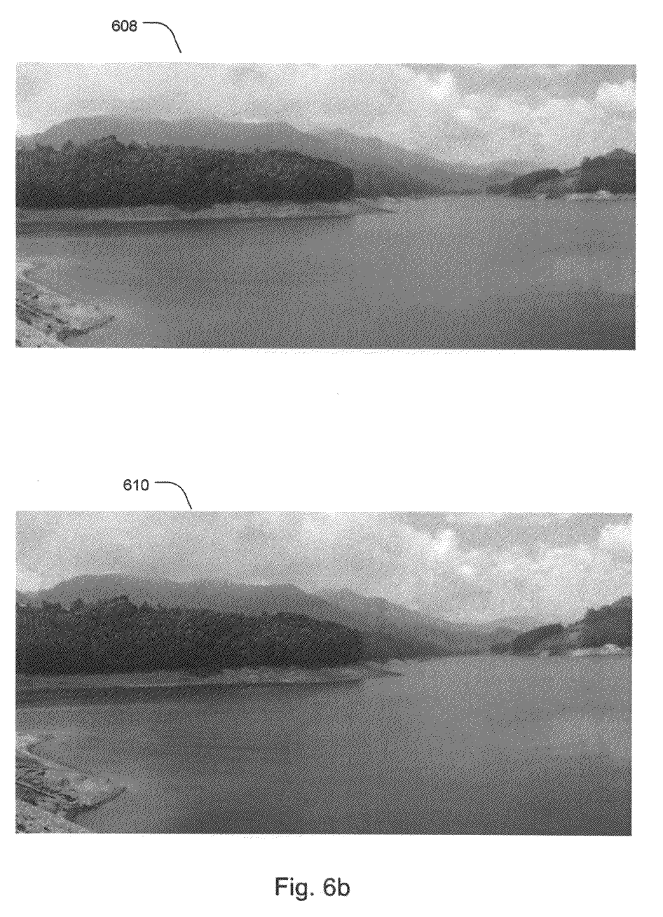

FIG. 6 illustrates the performance of the disclosed methods and systems for panoramic image generation in accordance to certain embodiments of the disclosed systems and methods. Accordingly, FIG. 6 shows a scene 600 that has a left image 602 and a right image 604. The panoramic image generated by systems known in the art (1 and 2) are shown as images 606 and 608. Panoramic image 610 is the resulting image obtained by employing the disclosed methods and systems.

Any other combination of all the techniques discussed herein is also possible. The foregoing description has been presented for purposes of illustration and description. Furthermore, the description is not intended to limit the invention to the form disclosed herein. While a number of exemplary aspects and embodiments have been discussed above, those of skill in the art will recognize certain variations, modifications, permutations, additions, and sub-combinations thereof. It is therefore intended that the following appended claims and claims hereafter introduced are interpreted to include all such variations, modifications, permutations, additions, and sub-combinations as are within their true spirit and scope.

I/We claim:

1. A method for generating a panoramic image of a scene, the method comprises:
acquiring a first image and a second image of the scene;
registering the first and the second images based at least in part on spatial relations of image data in an overlap region between the first and the second images; and
merging the registered images based at least in part on a block based mean of the overlap region between the first and second images to generate the panoramic image.

2. The method as in claim 1, wherein the acquiring comprises rotating an image capturing device about an axis and/or moving the image capturing device substantially parallel to a plane of the first image, the rotating and/or moving being performed after acquiring the first image and before acquiring the second image.

3. The method as in claim 1, wherein the acquiring comprises establishing an overlap region between the first image and second image, the extent of overlap region lying in the range of 40% to 70%.

4. The method as in claim 1, wherein the acquiring comprises capturing the second image subsequent to a change in image intensity with respect to the first image.

5. The method as in claim 1, wherein the registering comprises detecting one or more features in the first image and second image.

6. The method as in claim 5, wherein the detecting is performed by Harris corner detection technique.

7. The method of claim 5, wherein the registering further comprises matching the one or more detected features based at least in part on the spatial relations of image data in the overlap region.

8. The method of claim 7, wherein the matching comprises:
selecting a pair of feature points in a left image and a right image of the scene, the left image and right image corresponding to the first image and the second image respectively;
determining a first left distance and a first right distance between the selected pair of features in the left image and the right image respectively; and
determining a first left angle and a first right angle between the selected pair of features in the left image and the right image respectively.

9. The method of claim 8, wherein the spatial relations correspond to distance and angle between the selected pair of features in the left image and right image respectively.

10. The method of claim 8, wherein the matching further comprises:
computing a first adaptive distance threshold corresponding to the first left distance;
determining a first difference between the first left distance and the first right distance; and
comparing the determined first difference with the first adaptive distance threshold.

11. The method of claim 10, wherein the matching further comprises:
determining, based on the comparing, a difference between the first left angle and the first right angle; and
determining a first rotation direction based at least in part on the first left angle, first right angle and the determined difference between the first left angle and the first right angle.

12. The method of claim 11, wherein the matching further comprises:
comparing the difference between the first left angle and the first right angle with an angle threshold; and
selecting, based on the comparing with the angle threshold, a second and a third feature in the left image and the right image respectively.

13. The method of claim 12, wherein the matching further comprises:
determining a second left distance between the second feature and one of the selected pair of features in the left image;
determining a second right distance between the third feature and one of the selected pair of feature in the right image;
determining a second left angle between the second feature and the one of selected pair of features in the left image; and
determining a second right angle between the third feature and the one of selected pair of features in the right image.

14. The method of claim 13, wherein the matching further comprises:
computing a second adaptive distance threshold corresponding to the second left distance;
determining a second difference between the second left distance and the second right distance; and
comparing the determined second difference with the second adaptive distance threshold.

15. The method of claim 14, wherein the matching further comprises:
determining, based on the comparing of the determined second difference with the second adaptive threshold, a difference between the second left angle and the second right angle; and
determining a second rotation direction based at least in part on the second left angle, second right angle and the determined difference between the second left angle and the second right angle.

16. The method of claim 15, wherein the matching further comprises:
comparing the first rotation direction and the second rotation direction; and
setting, based on the comparison of the first and second rotation directions, a rotation flag value to 1.

17. The method of claim 16, wherein the matching further comprises:
discarding one or more of the first rotation direction and the second rotation direction if either of the corresponding first and second angle differences are less than or equal to 3.

18. The method of claim 10, wherein the determining of the first or second adaptive distance thresholds comprises:
setting the first or the second adaptive distance thresholds to 2 if the first left distance and second left distance is less than 35 respectively;
setting the first or second adaptive distance thresholds to 4 if the first left distance and second left distance is less than 100 respectively; and
setting the first or second adaptive distance thresholds to 6 if the first left distance and second left distance is greater than 100 respectively.

19. The method of claim 11, wherein the determining of the first and second rotation direction comprises adjusting the differences between the first, second left and right angles respectively, the adjusting resulting in assigning a value of −1 or +1 to the first and second rotation direction to represent anti-clockwise direction and clockwise direction respectively.

20. The method of claim 12, wherein the comparing the difference between the first left angle and the first right angle with a angle threshold comprises setting the angle threshold to a value of +15 or −15 degrees.

21. The method as in claim 17, wherein the matching further comprises generating a set of matched pair of features based at least in part on distance between the selected pair of features in the left and right image respectively.

22. The method as in claim 21, wherein the matching further comprises referring the generated set of matched pair of features as best match set if the number of matched pair of features in the generated set exceeds a best match count and stopping further processing for the matching.

23. The method as in claim 22, wherein the best match count is 16.

24. The method as in claim 21, wherein the matching further comprises referring the generated set of matched pair of features as predominant match set if the number of matched pair of features in the generated set exceeds a predominant match count.

25. The method as in claim 24, wherein the predominant match count is 10.

26. The method as in claim 24, wherein the matching further comprises stopping further processing when the number of predominant match sets exceeds a predominant set threshold.

27. The method as in claim 26, wherein the predominant threshold is 15.

28. The method of claim 1, wherein the merging comprises stitching and blending the first image and the second image to obtain an interim panoramic image.

29. The method of merging one or more registered images of a scene to generate a panoramic image of the scene, the method comprising:
computing, for each of a plurality of color planes associated with the scene, block wise mean intensity differences in an overlap region between the one or more registered images, the block being characterized by a predefined dimension;
smoothing a curve representing random variations in the computed mean intensity differences by a second order polynomial fit curve;
finding a linear fit that corresponds to a straight line between first and last values of the smoothened curve using a first order least squares polynomial fit; and
determining a maximum slope change point on the first order least squares polynomial fit curve, the maximum slope change point corresponding to x-coordinate at which distance between the linear fit and the first order least squares polynomial fit curve is maximum.

30. The method of claim 29, wherein the block has a dimension of up to 20 rows and up to 50 columns on each side of a stitch point between the one or more registered images, the stitch point lying on a stitching line for stitching the one or more registered images.

31. The method of claim 29, wherein the performing comprises:
determining maximum slope change points for intensity differences corresponding to each of the plurality of color planes; and
computing an average of the determined maximum slope change points to determine a final slope change point.

32. The method of claim 29, wherein the plurality of color planes correspond to one of the color spaces comprising: RGB, CMYK, gray space, and the like.

33. The method of claim 31, wherein the performing comprises:
determining a final linear fit that corresponds to a first straight line between the first value and the maximum slope change point and a second straight line between the maximum slope change point and the last value on the first order least squares polynomial fit curve.

34. The method of claim 31, wherein the performing comprises normalizing an interim panoramic image, obtained by stitching and blending of the one or more registered images, by using the mean intensity difference data associated with the final linear fit.

35. A computing based system for generating panoramic image of a scene, the system comprising:
an image acquisition module configured to acquire a first image and a second image of the scene;
an image registration module configured to register the first and the second images based at least in part on spatial relations of image data in an overlap region between the first and the second images; and
an image merging module configured to merge the registered images based at least in part on a block based mean of the overlap region between the first and second images to generate the panoramic image.

36. The system of claim 35, wherein the image registration module is further configured to detect one or more features in the first and second images.

37. The system of claim 35, wherein the image registration module comprises a feature matching module configured to match one or more detected features based at least in part on the spatial relations of image data in the overlap region.

38. The system of claim 35, wherein the image registration module is further configured to estimate a rotational transformation model for mapping the second image to the first image.

39. The system of claim 35, wherein the image registration module is further configured to:
resize the first and second image to small dimensions prior to detecting and matching of features in the first and second image; and
scale the first and second image to original size prior to merging of the first and second image.

40. The system of claim 35, wherein the image merging module is further configured to stitch and blend the registered images to obtain an interim panoramic image.

41. The system of claim 40, wherein the image merging module comprises an intensity correction module configured to perform a block based intensity correction on the interim panoramic image.

42. A method for matching features points of left image and right image of a scene captured for generating a panoramic image of the scene, the method comprising:
determining number of feature points in the left image and the right image;
selecting a pair of feature points each from the left image and the right image respectively;
matching geometrical properties of the selected pair of feature points in the left image and the selected pair of feature points in the right image, the geometric properties comprising distance and angle between the selected pair of feature points in respective images; and
upon finding a match, storing the selected pairs of feature points.

43. The method of claim 42, wherein the determining comprises detecting a plurality of feature points in the left image and right image.

44. The method of claim 42, wherein the matching comprises:
determining a distance and an angle between the selected pair of feature points in the left image;
determining distance and angle between the selected pair of feature points in the right image; and
comparing the determined distances and the angles corresponding to the left image and the right image to determine whether a match has been found.

45. The method of claim 44, wherein the matching further comprises:
selecting a new feature point in the left image;
determining distance and angle between the new feature point and one of the previously selected pair of feature points in the left image;
selecting a new feature point in the right image;
determining distance and angle between the new feature point and one of the previously selected pair of feature points in the right image; and
comparing the determined distances and the angles corresponding to the new corner feature points in the left image and the right image respectively to determine whether a new match has been found.

46. The method of claim 44, wherein the comparing further comprises determining an adaptive distance threshold based at least in part on the distance between the feature points of the left image.

47. The method of claim 44, wherein the comparing further comprises setting an angle threshold.

48. The method of claim 14, wherein the determining of the first or second adaptive distance thresholds comprises:
setting the first or the second adaptive distance thresholds to 2 if the first left distance and second left distance is less than 35 respectively;
setting the first or second adaptive distance thresholds to 4 if the first left distance and second left distance is less than 100 respectively; and
setting the first or second adaptive distance thresholds to 6 if the first left distance and second left distance is greater than 100 respectively.

49. The method of claim 15, wherein the determining of the first and second rotation direction comprises adjusting the differences between the first, second left and right angles respectively, the adjusting resulting in assigning a value of −1 or +1 to the first and second rotation direction to represent anti-clockwise direction and clockwise direction respectively.

50. The method of claim 31, wherein the plurality of color planes correspond to one of the color spaces comprising: RGB, CMYK, gray space, and the like.

51. The method of claim 45, wherein the comparing further comprises determining an adaptive distance threshold based at least in part on the distance between the feature points of the left image.

52. The method of claim 45, wherein the comparing further comprises setting an angle threshold.
